(19) United States
(12) Patent Application Publication
(10) Pub. No.: US 2026/0269861 A1
(43) Pub. Date: Sep. 10, 2026

(54) ANTENNA SWITCHING METHOD AND ANTENNA SWITCHING SYSTEM

(71) Applicant: WNC Corporation, Hsinchu (TW)

(72) Inventors: Zhiqiang WANG, Hsinchu (TW); Zhengchang ZHAI, Hsinchu (TW); Tzu-Hao LU, Hsinchu (TW)

(21) Appl. No.: 19/266,256

(22) Filed: Jul. 11, 2025

(30) Foreign Application Priority Data
Mar. 4, 2025 (TW) 114107870

(51) Int. Cl. H04B 1/44; H01Q 1/24

(52) U.S. Cl. CPC H04B 1/44; H01Q 1/24

(57) ABSTRACT

An antenna switching method includes performing a software configuration step corresponding to hardware identification according to a hardware identification code information to generate a configuration software information corresponding to an antenna module. Hardware identification code information includes a plurality of hardware identification codes. Configuration software information includes a plurality of configuration softwares. Configuration softwares correspond to the hardware identification codes, respectively. Antenna switching method further includes storing hardware identification code information, configuration software information and a current hardware identification code to a memory of a communication device. Current hardware identification code corresponds to an antenna configuration and is equal to one of the hardware identification codes. Antenna switching method further includes obtaining one configuration software corresponding to one hardware identification code from the memory after booting up, and performing initialization to the communication device according to the one of the configuration softwares.

### RELATED APPLICATIONS

This application claims the benefit of priority to Taiwan Patent Application No. 114107870, filed on Mar. 4, 2025. The entire content of the above identified application is incorporated herein by reference.

### BACKGROUND

### Technical Field

The present disclosure relates to a switching method and a switching system, particularly to an antenna switching method and an antenna switching system.

### Description of Related Art

For hardware products in different regions, conventional techniques generally use different software systems for hardware adaptation. Furthermore, in the maintenance of software systems, conventional techniques conduct isolated maintenance for hardware differences by using different software branches. Although these conventional techniques ensure unique correspondence between software and hardware, such conventional techniques have low fault tolerance rates, and require a plurality of software versions to be released for a plurality of hardware products during related product version releases, thus significantly increasing the complexity of version release and maintenance. Moreover, these conventional techniques are disadvantageous to version docking between companies and customers, which easily lead to errors in version releases, thereby increasing the risk of customers using incorrect software versions.

Additionally, for updates related to hardware antenna switching, the conventional techniques typically require relevant antenna hardware engineers and software engineers to collaboratively replan and reconfigure according to the differences in antenna changes. In this way, during product iteration and upgrades, companies need to invest more research and development personnel, and more communication and development time is required in the development process. Therefore, the costs related to product development and maintenance greatly increase, and the efficiency is relatively low. Furthermore, customers may have a poor satisfaction with the company's development services. In view of the above, there is currently a lack of an antenna switching method and an antenna switching system in the market that provides uniformity while at the same time improves fault tolerance and efficiency, reduces the company's development costs, and enhances customer satisfaction. Thus, relevant practitioners are seeking solutions.

### SUMMARY

An antenna switching method is provided according to an embodiment of the method aspect of the present disclosure. The antenna switching method is used for an electronic device that includes a communication device and an antenna module, and the antenna module is connected to the communication device and switched to an antenna configuration. The antenna switching method includes executing, by a processor of the communication device, a step of configuring software corresponding to hardware identification based on a hardware identification code information, so as to generate a configuration software information corresponding to the antenna module, wherein the hardware identification code information includes a plurality of hardware identification codes, the configuration software information includes a plurality of configuration softwares, and the configuration softwares correspond to the hardware identification codes, respectively; storing, by the processor, the hardware identification code information, the configuration software information, and a current hardware identification code in a memory of the communication device, wherein the current hardware identification code corresponds to the antenna configuration and is equal to one of the hardware identification codes; and reading, by the processor, one of the configuration softwares corresponding to the one of the hardware identification codes from the memory through a boot-up operation, and initializing the communication device based on the one of the configuration softwares.

An antenna switching method is provided according to another embodiment of the method aspect of the present disclosure. The antenna switching method is used for an electronic device that includes a communication device and an antenna module, and the antenna module is connected to the communication device and switched from a first antenna configuration to a second antenna configuration. The first antenna configuration is different from the second antenna configuration. The antenna switching method includes: updating, by a processor of the communication device, a first hardware identification code information corresponding to the first antenna configuration into a second hardware identification code information corresponding to the second antenna configuration, wherein the first hardware identification code information differs from the second hardware identification code information; executing, by the processor, a step of configuring software corresponding to hardware identification based on the second hardware identification code information, so as to generate a configuration software information corresponding to the antenna module, wherein the second hardware identification code information includes a plurality of hardware identification codes, the configuration software information includes a plurality of configuration softwares, and the configuration softwares corresponds to the hardware identification codes, respectively; storing, by the processor, the second hardware identification code information, the configuration software information, and a current hardware identification code in a memory of the communication device, wherein the current hardware identification code corresponds to the second antenna configuration and is equal to one of the hardware identification codes; and reading, by the processor, one of the configuration softwares corresponding to the one of the hardware identification codes from the memory through a boot-up operation, and initializing the communication device based on the one of the configuration softwares.

An antenna switching system is provided according to an embodiment of the structural aspect of the present disclosure. The antenna switching system includes an antenna module and a communication device. The antenna module is switched to an antenna configuration. The communication device is connected to the antenna module, and the communication device includes a memory and a processor. The memory is used to store a hardware identification code information, a configuration software information, and a current hardware identification code, wherein the hardware identification code information includes a plurality of hardware identification codes, the configuration software information includes a plurality of configuration softwares, the configuration softwares correspond to the hardware identification codes, respectively, the current hardware identification code corresponds to the antenna configuration, and the current hardware identification code is equal to one of the hardware identification codes. The processor is connected to the memory and receives the hardware identification code information. The processor executes a step of configuring software information corresponding to hardware identification based on the hardware identification code information, so as to generate a configuration software information corresponding to the antenna module. The processor reads one of the configuration softwares corresponding to the one of the hardware identification codes from the memory through a boot-up operation, and the processors initializes the communication device based on the one of the configuration softwares.

### BRIEF DESCRIPTION OF THE DRAWINGS

The described embodiments may be better understood by reference to the following description and the accompanying drawings.

FIG. 1 is a schematic view of the antenna switching system according to the first embodiment of the present disclosure.

FIG. 2 is a flowchart of the antenna switching method according to the second embodiment of the present disclosure.

FIG. 3 is a flowchart of a step of configuring software corresponding to hardware identification in the method of FIG. 2.

FIG. 4 is a flowchart of the initialization process of the communication device in FIG. 1 during a boot-up operation.

FIG. 5 is another flowchart of the initialization process of the communication device in FIG. 1 during the boot-up operation.

FIG. 6 is a schematic view of the antenna switching system according to the third embodiment of the present disclosure.

FIG. 7 is a flowchart of the antenna switching method according to the fourth embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The following describes several embodiments of the present disclosure with reference to the drawings. In this specification, when a component is “connected” to another component, it may refer to the component being directly connected to the other component, or it may refer to one component being indirectly connected to another component, meaning that other components are interposed between the component and the other component.

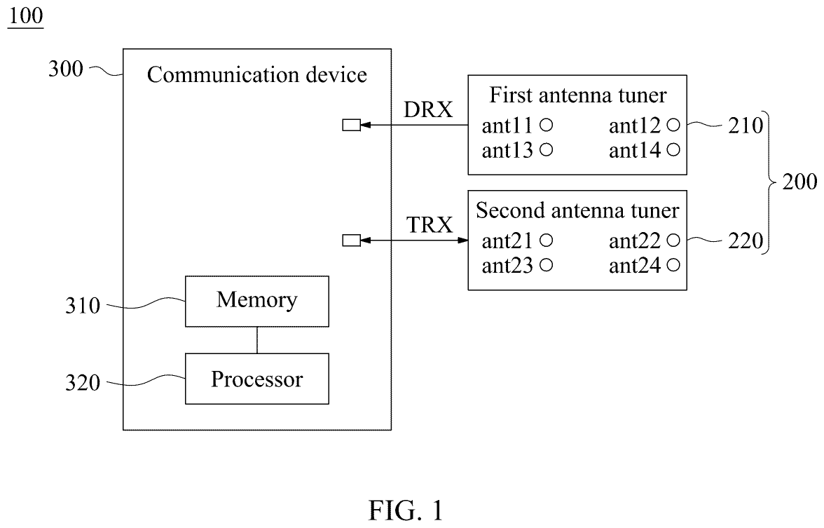

Please refer to FIG. 1, which is a schematic view of the antenna switching system 100 according to the first embodiment of the present disclosure. The antenna switching system 100 includes an antenna module 200 and a communication device 300. The antenna module 200 is switched to an antenna configuration. The communication device 300 is connected to the antenna module 200 and includes a memory 310 and a processor 320. The memory 310 is used to store hardware identification code information, configuration software information, and a current hardware identification code. The hardware identification code information includes a plurality of hardware identification codes. The configuration software information includes a plurality of configuration softwares, and the configuration softwares correspond to hardware identification codes, respectively. The current hardware identification code corresponds to the antenna configuration and is equal to one of the hardware identification codes. The processor 320 connects to the memory 310 and receives the hardware identification code information. The processor 320 executes a step of configuring software corresponding to hardware identification based on the hardware identification code information, so as to generate configuration software information corresponding to the antenna module 200. The processor 320 reads one of the configuration softwares corresponding to the one of the hardware identification codes from the memory 310 through a boot-up operation, and initializes the communication device 300 based on the one of the configuration softwares.

The antenna module 200 includes a first antenna tuner 210 and a second antenna tuner 220. The first antenna tuner 210 connects to the communication device 300 and is used to electrically connect a plurality of first antennas ant11, ant12, ant13, ant14. The second antenna tuner 220 connects to the communication device 300 and is used to electrically connect a plurality of second antennas ant21, ant22, ant23, ant24. The first antenna tuner 210 is a receive (DRX) antenna switch, used to receive signals from one of the first antennas ant11, ant12, ant13, ant14. The second antenna tuner 220 is a transceive (TRX) antenna switch, used to receive or transmit signals from one of the second antennas ant21, ant22, ant23, ant24. The antenna configuration corresponds to a plurality of switch states of the first antenna tuner 210 and the second antenna tuner 220.

The present disclosure can be applied to communication products containing a Radio Frequency Card (RFC). In one embodiment, the memory 310 can be a non-volatile (NV) memory, and this NV memory can be a static NV memory. The communication device 300 can be a modem and execute a Linux operating system. However, the present disclosure is not limited to the above.

Please refer to FIG. 1, Table 1 and Table 2 together, wherein Table 1 shows the switch states of the first antenna tuner 210 applied to a plurality of antennas, and Table 2 shows the switch states of the second antenna tuner 220 applied to a plurality of antennas. The switch states in Table 1 and Table 2 can ensure that only one antenna is kept open for the same antenna tuner (for example, among the four first antennas ant11, ant12, ant13, ant14 in Table 1, only one will be open, indicated as “1”. The other three will be closed, indicated as “0”), to ensure that the related antenna signal power does not leak. Based on the defined switch states, combined with the configuration of the current hardware, developers (such as antenna engineers) can select the configuration with the best signal quality as the default antenna state through testing the antenna power conditions of the transmit (TX) antenna and various testing conditions of the receive (RX) antenna such as the Reference Signal Receiving Power (RSRP), Received Signal Strength Indication (RSSI), and Reference Signal Receiving Quality (RSRQ), along with Block Error Rate (BLER) throughput testing and voice calls under an Over The Air (OTA) environment, to ensure the performance advantages of the current hardware.

TABLE 1
Switch state (“1” represents open,
“0” represents closed)

| | ant11 | ant12 | ant13 | ant14 |
|---|---|---|---|---|
| First | 1 | 0 | 0 | 0 |
| antenna | 0 | 1 | 0 | 0 |
| tuner | 0 | 0 | 1 | 0 |
| | 0 | 0 | 0 | 1 |

TABLE 2
Switch state(“1” represents open,
“0” represents closed)

| | ant21 | ant22 | ant23 | ant 24 |
|---|---|---|---|---|
| Second | 1 | 0 | 0 | 0 |
| antenna | 0 | 1 | 0 | 0 |
| tuner | 0 | 0 | 1 | 0 |
| | 0 | 0 | 0 | 1 |

Please refer to FIG. 1, Table 1, Table 2, and Table 3 together, wherein Table 3 shows the hardware identification code information (relationship table of the Hardware Identification (HWID) code corresponding to the configuration of the antenna module 200). The processor 320 defines the hardware identification code information based on all possible antenna configurations corresponding to the antenna module 200, wherein the quantity of the antenna configurations is equal to the quantity of the hardware identification codes and the quantity of the configuration softwares. For example, in Table 3, the quantity of antenna configurations is equal to 16 (under the condition that only one antenna remains open for the same antenna tuner, the total quantity of all possible antenna configurations for the first antenna tuner 210 and the second antenna tuner 220 is 4×4=16), and the quantity of hardware identification codes and the quantity of configuration softwares are both equal to 16. In one embodiment, the antenna engineer can make adjustments according to different antenna configurations in different regions to meet the configuration needs of the current region. Subsequently, a fixed hardware identification code can be directly written into the NV memory, and the communication device 300 will load the corresponding configuration software through the boot-up operation, allowing the same version of software to correspondingly load the related system software under different hardware configurations, thereby providing communication services related to the communication device 300.

TABLE 3

| | First antenna tuner | | | | Second antenna tuner | | | |
|---|---|---|---|---|---|---|---|---|
| HWID | ant11 | ant12 | ant13 | ant14 | ant21 | ant22 | ant23 | ant24 |
| 001 | 1 | 0 | 0 | 0 | 1 | 0 | 0 | 0 |
| 002 | 1 | 0 | 0 | 0 | 0 | 1 | 0 | 0 |
| 003 | 1 | 0 | 0 | 0 | 0 | 0 | 1 | 0 |
| 004 | 1 | 0 | 0 | 0 | 0 | 0 | 0 | 1 |
| 005 | 0 | 1 | 0 | 0 | 1 | 0 | 0 | 0 |
| 006 | 0 | 1 | 0 | 0 | 0 | 1 | 0 | 0 |
| 007 | 0 | 1 | 0 | 0 | 0 | 0 | 1 | 0 |
| 008 | 0 | 1 | 0 | 0 | 0 | 0 | 0 | 1 |
| 009 | 0 | 0 | 1 | 0 | 1 | 0 | 0 | 0 |
| 010 | 0 | 0 | 1 | 0 | 0 | 1 | 0 | 0 |
| 011 | 0 | 0 | 1 | 0 | 0 | 0 | 1 | 0 |
| 012 | 0 | 0 | 1 | 0 | 0 | 0 | 0 | 1 |
| 013 | 0 | 0 | 0 | 1 | 1 | 0 | 0 | 0 |
| 014 | 0 | 0 | 0 | 1 | 0 | 1 | 0 | 0 |
| 015 | 0 | 0 | 0 | 1 | 0 | 0 | 1 | 0 |
| 016 | 0 | 0 | 0 | 1 | 0 | 0 | 0 | 1 |

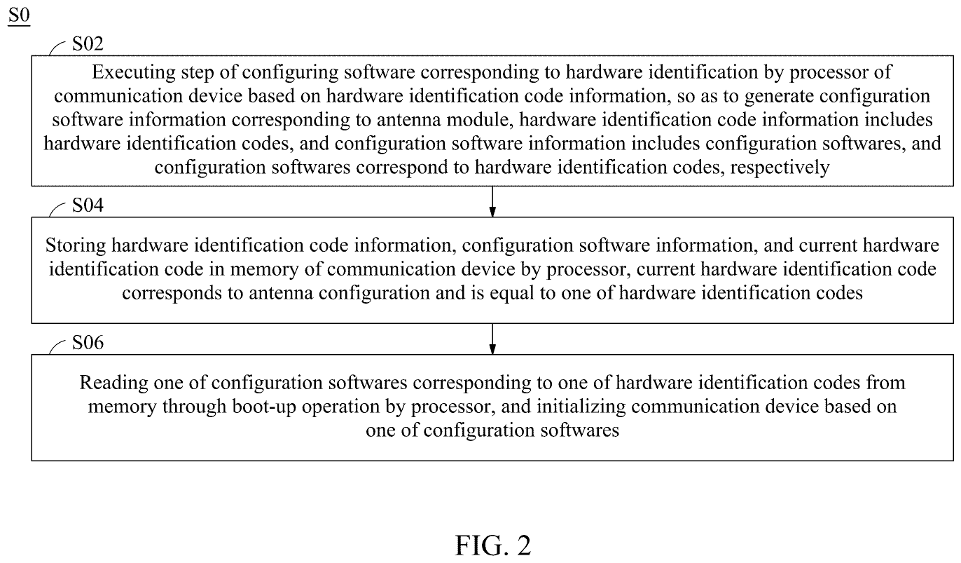

Please refer to FIG. 1 and FIG. 2 together, wherein FIG. 2 illustrates the flowchart of the antenna switching method S0 according to the second embodiment of the present disclosure. The antenna switching method S0 is used for an electronic device (such as the antenna switching system 100) that includes a communication device 300 and an antenna module 200, and the antenna module 200 is connected to the communication device 300 and switched to an antenna configuration. The antenna switching method S0 includes steps S02, S04, and S06. Step S02 includes executing a step of configuring software corresponding to hardware identification by a processor 320 of the communication device 300 based on hardware identification code information, so as to generate configuration software information corresponding to the antenna module 200. The hardware identification code information includes a plurality of hardware identification codes, and the configuration software information includes a plurality of configuration softwares, and the configuration softwares correspond to the hardware identification codes, respectively. Step S04 includes storing the hardware identification code information, configuration software information, and a current hardware identification code in a memory 310 of the communication device 300 by the processor 320. The current hardware identification code corresponds to the antenna configuration and is equal to one of the hardware identification codes. Step S06 includes reading one of the configuration softwares corresponding to the one of the hardware identification codes from the memory 310 through a boot-up operation by the processor 320, and initializing the communication device 300 based on the one of the configuration softwares.

Accordingly, the antenna switching system 100 and antenna switching method S0 of the present disclosure can use the same version of software under different hardware configurations, not only making it convenient for customer operation and avoiding software re-burning, but also improving fault tolerance, maintaining uniformity, reducing costs, increasing efficiency, and enhancing customer satisfaction.

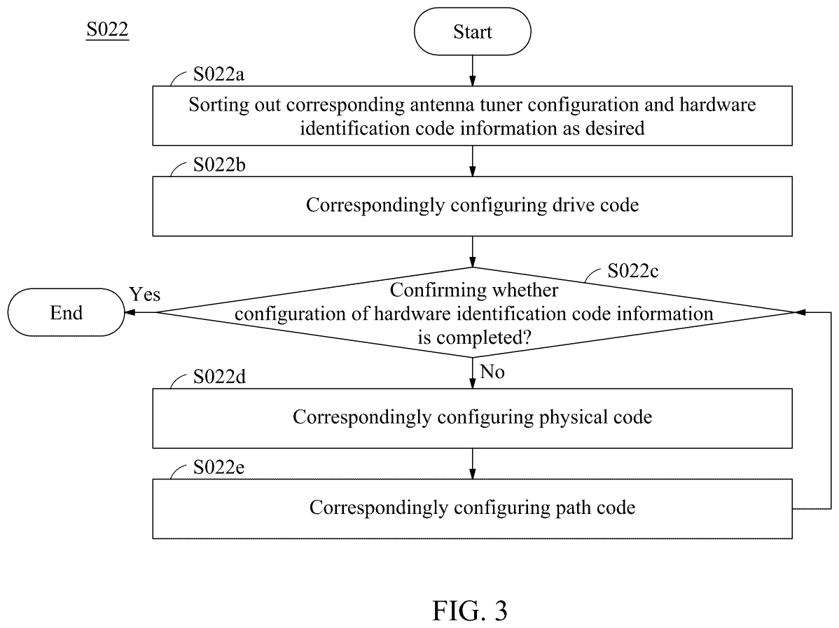

Please refer to FIG. 1, FIG. 2, FIG. 3 and Table 3 together, wherein FIG. 3 illustrates the flowchart of the step S022 of configuring software corresponding to hardware identification in step S02 of FIG. 2. The step S022 of configuring software corresponding to hardware identification includes steps S022a, S022b, S022c, S022d, and S022e. Step S022a includes sorting out the corresponding antenna tuner configuration and hardware identification code information (such as Table 3) by the processor 320 as desired. Step S022b includes configuring a drive code corresponding to an antenna tuner of the antenna module 200 based on the hardware identification code information and a specification data of the antenna tuner of the antenna module 200 (such as datasheet data) by the processor 320. The antenna tuner can be one of the first antenna tuner 210 and the second antenna tuner 220. Step S022c is a configuration complete confirmation step, which includes confirming whether the configurations of the hardware identification codes and the configuration softwares (the configuration of the hardware identification code information) are completed by the processor 320, generating a confirmation result, and determining whether to execute steps S022d and S022e based on the confirmation result. Step S022d is a physical code configuration step corresponding to the antenna tuner, which includes configuring the physical code corresponding to the antenna tuner based on the hardware identification code information and specification data by the processor 320. Step S022e is a path code configuration step corresponding to the antenna tuner, which includes configuring the path code corresponding to the antenna tuner based on the hardware identification code information, specification data, and drive code by the processor 320. The path code can represent the switching state of the antenna tuner for TRX/DRX paths. Additionally, after step S022e is executed, the processor 320 repeats step S022c to generate a confirmation result again. When the confirmation result is affirmative, the processor 320 ends the step S022 of configuring software corresponding to hardware identification; conversely, when the confirmation result is negative, the processor 320 repeats steps S022d and S022e.

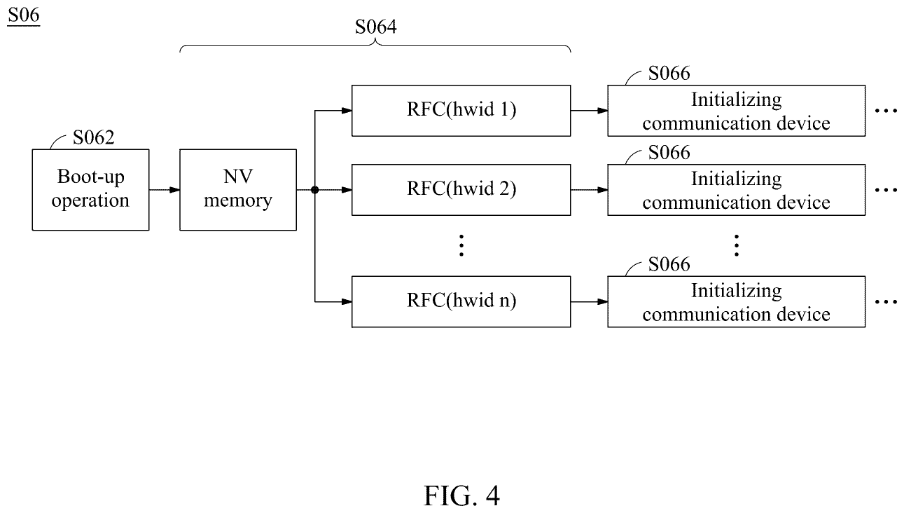

Please refer to FIG. 1, FIG. 2, and FIG. 4 together, wherein FIG. 4 illustrates another flowchart of the initialization process of the communication device 300 in FIG. 1 during a boot-up operation. When the communication device 300 executes step S06, step S06 further includes steps S062, S064, and S066. Step S062 includes executing the boot-up operation. Step S064 includes selecting the one of the configuration softwares corresponding to the one of the hardware identification codes based on the current hardware identification code of the NV memory by the processor 320, such that the one of the configuration softwares matches the antenna configuration. Step S066 includes initializing the communication device 300 based on the one of the configuration softwares by the processor 320. The configuration softwares respectively correspond to a plurality of software identification codes (RFC (hwid 1), RFC (hwid 2), . . . , RFC (hwid n)), wherein n is a positive integer equal to the quantity of the hardware identification codes (HWID).

Moreover, before the communication device 300 executes step S06, the software versions of all configurations of the hardware identification code information will be burned into the communication device 300 for subsequent use. After the communication device 300 executes step S06 (i.e., after successful initialization), the antenna switching system 100 will provide communication-related services for subsequent modules and ensure that the communication services are operational.

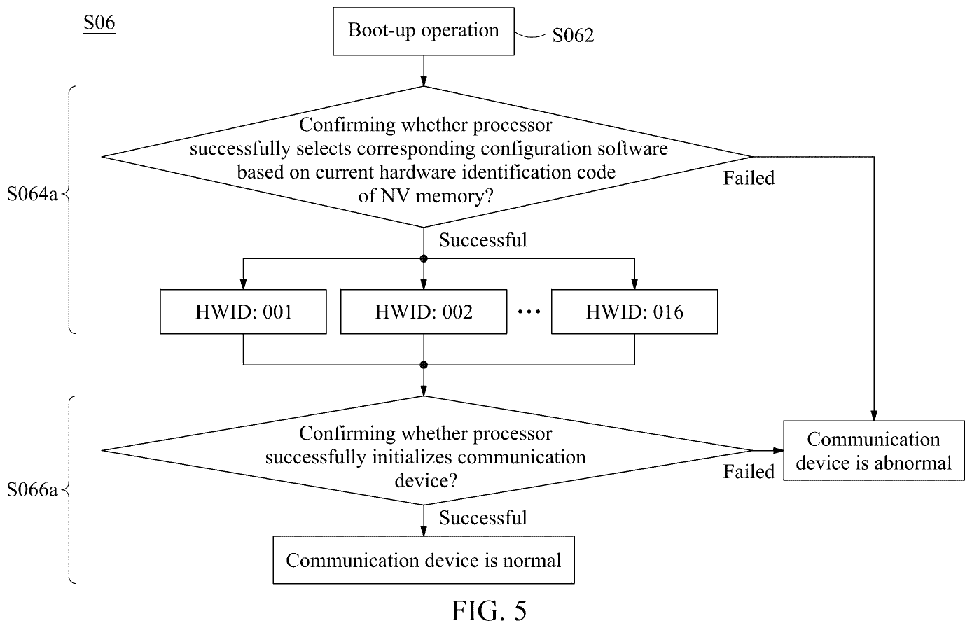

Please refer to FIG. 1, FIG. 2, FIG. 4, FIG. 5, and Table 3 together, wherein FIG. 5 illustrates another flowchart of the initialization process of the communication device 300 in FIG. 1 during the boot-up operation. When the communication device 300 executes step S06, step S06 further includes steps S062, S064a, and S066a. Step S062 includes executing the boot-up operation. Step S064a includes confirming whether the processor 320 successfully selects the one of the configuration softwares corresponding to the one of the hardware identification codes (such as “HWID: 001”, “HWID: 002”, . . . , “HWID: 016”, corresponding to the HWID in Table 3) based on the current hardware identification code of the NV memory, such that the one of the configuration softwares matches the antenna configuration. If successful, the communication device 300 is initialized based on the one of the configuration softwares; if failed, it indicates an abnormality in the communication device 300 (the communication device 300 is abnormal). Step S066a includes confirming whether the processor 320 successfully initializes the communication device 300. If successful, it indicates that the communication device 300 is normal; if failed, it indicates an abnormality in the communication device 300.

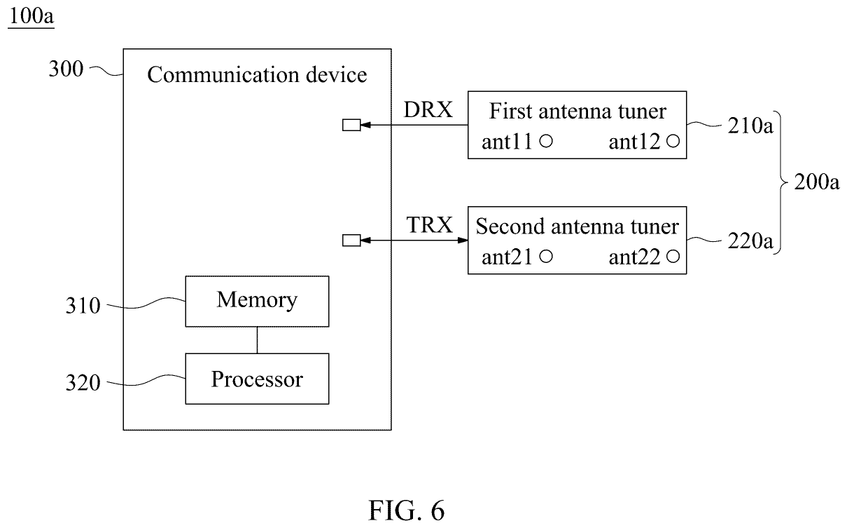

Please also to FIG. 1 and FIG. 6 together, wherein FIG. 6 illustrates a schematic view of the antenna switching system 100a according to the third embodiment of the present disclosure. The antenna switching system 100a includes an antenna module 200a and a communication device 300. The antenna module 200a has a first antenna configuration. The communication device 300 connects to the antenna module 200a and includes a memory 310 and a processor 320. The antenna module 200a includes a first antenna tuner 210a and a second antenna tuner 220a. The first antenna tuner 210a connects to the communication device 300 and is used to electrically connect a plurality of first antennas ant11, ant12. The second antenna tuner 220a connects to the communication device 300 and is used to electrically connect a plurality of second antennas ant21, ant22. The first antenna tuner 210a is a receive (DRX) antenna switch, used to receive signals from one of the first antennas ant11, ant12. The second antenna tuner 220a is a transceive (TRX) antenna switch, used to receive or transmit signals from one of the second antennas ant21, ant22. The antenna configuration corresponds to a plurality of switch states of the first antenna tuner 210a and the second antenna tuner 220a. The communication device 300 in FIG. 6 is the same as the communication device 300 in FIG. 1, and its details are not repeated herein.

The antenna switching system 100a in FIG. 6 corresponds to the first antenna configuration, while the antenna switching system 100 in FIG. 1 corresponds to the second antenna configuration. In one embodiment, the electronic device can switch from the first antenna configuration in FIG. 6 to the second antenna configuration in FIG. 1, wherein the first antenna configuration differs from the second antenna configuration. The following will describe a detailed process of the antenna switching method S2 for switching from the first antenna configuration to the second antenna configuration.

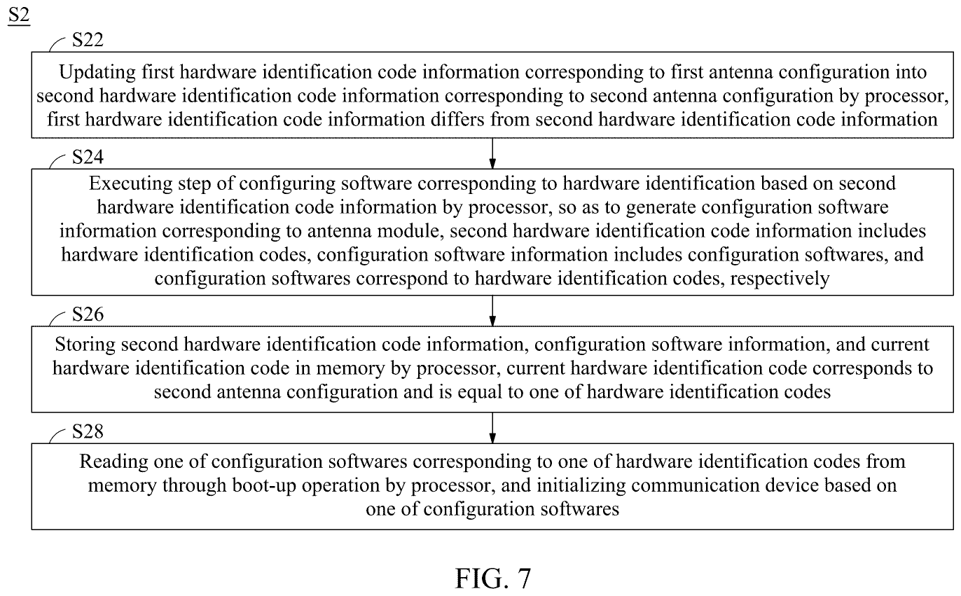

Please refer to FIG. 1, FIG. 2, FIG. 6, FIG. 7, Table 3, and Table 4 together, wherein FIG. 7 illustrates a flowchart of the antenna switching method S2 according to the fourth embodiment of the present disclosure, and Table 4 shows a first hardware identification code information (relationship table of the first Hardware Identification (HWID) code corresponding to the configuration of the antenna module 200a in FIG. 6). Table 3 can be regarded as a second hardware identification code information (relationship table of the second Hardware Identification (HWID) code corresponding to the configuration of the antenna module 200 in FIG. 1). The antenna switching method S2 in FIG. 7 includes steps S22, S24, S26, and S28. Step S22 includes updating the first hardware identification code information corresponding to the first antenna configuration (such as Table 4) into the second hardware identification code information corresponding to the second antenna configuration (such as Table 3) by the processor 320. The first hardware identification code information differs from the second hardware identification code information. Step S24 includes executing a step of configuring software corresponding to hardware identification based on the second hardware identification code information by the processor 320, so as to generate configuration software information corresponding to the antenna module 200. The second hardware identification code information includes a plurality of hardware identification codes, and the configuration software information includes a plurality of configuration softwares, and the configuration softwares correspond to the hardware identification codes, respectively. Step S26 includes storing the second hardware identification code information, the configuration software information, and a current hardware identification code in the memory 310 by the processor 320. The current hardware identification code corresponds to the second antenna configuration and is equal to one of the hardware identification codes. Step S28 includes reading one of the configuration softwares corresponding to the one of the hardware identification codes from the memory 310 through a boot-up operation by the processor 320, and initializing the communication device 300 based on the one of the configuration softwares.

TABLE 4

| | First antenna tuner | | Second antenna tuner | |
|---|---|---|---|---|
| HWID | ant11 | ant12 | ant21 | ant22 |
| 01 | 1 | 0 | 1 | 0 |
| 02 | 1 | 0 | 0 | 1 |
| 03 | 0 | 1 | 1 | 0 |
| 04 | 0 | 1 | 0 | 1 |

Accordingly, the antenna switching method S2 of the present disclosure can further expand the configurations of hardware identification codes and configuration softwares based on the actual situation of the current hardware, allowing the same version of software to be used under different hardware configurations, which not only makes it convenient for customer operation and avoids software re-burning, but also improves fault tolerance, maintains uniformity, reduces costs, increases efficiency, and enhances customer satisfaction.

In other embodiments, the electronic device can switch from the second antenna configuration in FIG. 1 into the first antenna configuration in FIG. 6, and utilizing the equivalent concept of the antenna switching method S2 in FIG. 7 to achieve dynamic and flexible loading of configuration softwares. The configurations of the hardware identification codes and configuration softwares can be further reduced based on the actual situation of the current hardware.

From the above embodiments, it can be seen that the techniques of the present disclosure has the following advantages. First, it can cater to the hardware differences of antenna switching during product iteration and upgrades, while also factoring in the differences of hardware products in different regions, allowing each product in different regions to achieve optimized network signal quality, thereby addressing the issues of the conventional techniques, such as the need to re-burn software for different hardware configurations, inconvenience of customer operation, low fault tolerance rate, high costs, low efficiency, and poor user satisfaction. Second, the same version of software can be used under different hardware configurations, and can dynamically and flexibly load the configuration software corresponding to the antenna hardware by modifying specific memory, effectively handling situations where the types and positions of external antennas on the hardware are changeable, making it suitable for applications in different regions with different antenna configurations and satisfying the needs for configuration changes during product iteration and upgrades. Third, the hardware identification codes and configuration softwares can be further expanded or reduced based on the actual situation of the current hardware, which not only makes it convenient for customer operation and avoids software re-burning, but also improves fault tolerance, maintains uniformity, reduces costs, increases efficiency, and enhances customer satisfaction.

The embodiments were chosen and described in order to explain the principles of the present disclosure and their practical applications. Alternative embodiments will become apparent to those skilled in the art to which the present disclosure pertains without departing from its spirit and scope.

What is claimed is:

1. An antenna switching method for an electronic device, the electronic device comprising a communication device and an antenna module, the antenna module being connected to the communication device and switched to an antenna configuration, the antenna switching method comprising:
executing, by a processor of the communication device, a step of configuring software corresponding to hardware identification based on a hardware identification code information, so as to generate a configuration software information corresponding to the antenna module, wherein the hardware identification code information comprises a plurality of hardware identification codes, the configuration software information comprises a plurality of configuration softwares, and the configuration softwares correspond to the hardware identification codes, respectively;
storing, by the processor, the hardware identification code information, the configuration software information, and a current hardware identification code in a memory of the communication device, wherein the current hardware identification code corresponds to the antenna configuration and is equal to one of the hardware identification codes; and
reading, by the processor, one of the configuration softwares corresponding to the one of the hardware identification codes from the memory through a boot-up operation, and initializing the communication device based on the one of the configuration softwares.

2. The antenna switching method according to claim 1, further comprising:
defining, by the processor, the hardware identification code information based on all possibilities of a plurality of antenna configurations corresponding to the antenna module;
wherein a quantity of the antenna configurations is equal to a quantity of the hardware identification codes and a quantity of the configuration softwares.

3. The antenna switching method according to claim 1, wherein the antenna module comprises:
a first antenna tuner, connected to the communication device and used to electrically connect a plurality of first antennas; and
a second antenna tuner, connected to the communication device and used to electrically connect a plurality of second antennas;
wherein the first antenna tuner is a receive (DRX) antenna switch for receiving signals from one of the first antennas, the second antenna tuner is a transceive (TRX) antenna switch for receiving or transmitting signals from one of the second antennas, and the antenna configuration corresponds to a plurality of switch states of the first antenna tuner and the second antenna tuner.

4. The antenna switching method according to claim 1, wherein the step of configuring software corresponding to hardware identification comprises:
configuring, by the processor, a drive code corresponding to an antenna tuner of the antenna module based on the hardware identification code information and a specification data of the antenna tuner; and
executing, by the processor, a configuration complete confirmation step, wherein the configuration complete confirmation step comprises generating a confirmation result by confirming whether configurations of the hardware identification codes and the configuration softwares are completed, and determining whether to execute a physical code configuration step and a path code configuration step based on the confirmation result.

5. The antenna switching method according to claim 4, wherein:
the physical code configuration step comprises configuring, by the processor, a physical code corresponding to the antenna tuner based on the hardware identification code information and the specification data;
the path code configuration step comprises configuring, by the processor, a path code corresponding to the antenna tuner based on the hardware identification code information, the specification data, and the drive code;
after the path code configuration step is executed, the processor repeats the configuration complete confirmation step to generate the confirmation result;
when the confirmation result is affirmative, the processor ends the step of configuring software corresponding to hardware identification; and
when the confirmation result is negative, the processor executes the physical code configuration step and the path code configuration step.

6. The antenna switching method according to claim 1, wherein the memory is a non-volatile (NV) memory, and the communication device executes a Linux operating system.

7. The antenna switching method according to claim 6, wherein step of reading, by the processor, the one of the configuration softwares corresponding to the one of the hardware identification codes from the memory through the boot-up operation comprises:
selecting, by the processor, the one of the configuration softwares corresponding to the one of the hardware identification codes based on the current hardware identification code of the NV memory, such that the one of the configuration softwares matches the antenna configuration.

8. An antenna switching method for an electronic device, the electronic device comprising a communication device and an antenna module, the antenna module being connected to the communication device and switched from a first antenna configuration to a second antenna configuration, the first antenna configuration being different from the second antenna configuration, the antenna switching method comprising:
updating, by a processor of the communication device, a first hardware identification code information corresponding to the first antenna configuration into a second hardware identification code information corresponding to the second antenna configuration, wherein the first hardware identification code information differs from the second hardware identification code information;
executing, by the processor, a step of configuring software corresponding to hardware identification based on the second hardware identification code information, so as to generate a configuration software information corresponding to the antenna module, wherein the second hardware identification code information comprises a plurality of hardware identification codes, the configuration software information comprises a plurality of configuration softwares, and the configuration softwares corresponds to the hardware identification codes, respectively;
storing, by the processor, the second hardware identification code information, the configuration software information, and a current hardware identification code in a memory of the communication device, wherein the current hardware identification code corresponds to the second antenna configuration and is equal to one of the hardware identification codes; and
reading, by the processor, one of the configuration softwares corresponding to the one of the hardware identification codes from the memory through a boot-up operation, and initializing the communication device based on the one of the configuration softwares.

9. The antenna switching method according to claim 8, further comprising:
defining, by the processor, the second hardware identification code information based on all possibilities of a plurality of second antenna configurations corresponding to the antenna module;
wherein a quantity of the second antenna configurations is equal to a quantity of the hardware identification codes and a quantity of the configuration softwares.

10. The antenna switching method according to claim 8, wherein the antenna module comprises:
a first antenna tuner, connected to the communication device and used to electrically connect a plurality of first antennas; and
a second antenna tuner, connected to the communication device and used to electrically connect a plurality of second antennas;
wherein the first antenna tuner is a receive (DRX) antenna switch for receiving signals from one of the first antennas, the second antenna tuner is a transceive (TRX) antenna switch for receiving or transmitting signals from one of the second antennas, and the second antenna configuration corresponds to a plurality of switch states of the first antenna tuner and the second antenna tuner.

11. The antenna switching method according to claim 8, wherein the step of configuring software corresponding to hardware identification comprises:
configuring, by the processor, a drive code corresponding to an antenna tuner of the antenna module based on the second hardware identification code information and a specification data of the antenna tuner; and
executing, by the processor, a configuration complete confirmation step, wherein the configuration complete confirmation step comprises generating a confirmation result by confirming whether configurations of the hardware identification codes and the configuration softwares are completed, and determining whether to execute a physical code configuration step and a path code configuration step based on the confirmation result.

12. The antenna switching method according to claim 11, wherein:
the physical code configuration step comprises configuring, by the processor, a physical code corresponding to the antenna tuner based on the second hardware identification code information and the specification data;
the path code configuration step comprises configuring, by the processor, a path code corresponding to the antenna tuner based on the second hardware identification code information, the specification data, and the drive code;
after the path code configuration step is executed, the processor repeats the configuration complete confirmation step to generate the confirmation result;
when the confirmation result is affirmative, the processor ends the step of configuring software corresponding to hardware identification; and
when the confirmation result is negative, the processor executes the physical code configuration step and the path code configuration step.

13. The antenna switching method according to claim 8, wherein the memory is a non-volatile (NV) memory, and the communication device executes a Linux operating system.

14. The antenna switching method according to claim 13, wherein step of reading, by the processor, the one of the configuration softwares corresponding to the one of the hardware identification codes from the memory through the boot-up operation comprises:
selecting, by the processor, the one of the configuration softwares corresponding to the one of the hardware identification codes based on the current hardware identification code of the NV memory, such that the one of the configuration softwares matches the second antenna configuration.

15. An antenna switching system, comprising:
an antenna module, switched to an antenna configuration; and
a communication device, connected to the antenna module and comprising:
a memory, used to store a hardware identification code information, a configuration software information, and a current hardware identification code, wherein the hardware identification code information comprises a plurality of hardware identification codes, the configuration software information comprises a plurality of configuration softwares, the configuration softwares correspond to the hardware identification codes, respectively, the current hardware identification code corresponds to the antenna configuration, and the current hardware identification code is equal to one of the hardware identification codes; and
a processor, connected to the memory and receiving the hardware identification code information, the processor executing a step of configuring software information corresponding to hardware identification based on the hardware identification code information, so as to generate a configuration software information corresponding to the antenna module, the processor reading one of the configuration softwares corresponding to the one of the hardware identification codes from the memory through a boot-up operation, and the processor initializing the communication device based on the one of the configuration softwares.

16. The antenna switching system according to claim 15, wherein the processor defines the hardware identification code information based on all possibilities of a plurality of antenna configurations corresponding to the antenna module, a quantity of the antenna configurations is equal to a quantity of the hardware identification codes and a quantity of the configuration softwares.

17. The antenna switching system according to claim 15, wherein the antenna module comprises:
a first antenna tuner, the first antenna tuner being connected to the communication device and used to electrically connect a plurality of first antennas; and
a second antenna tuner, the second antenna tuner being connected to the communication device and used to electrically connect a plurality of second antennas;
wherein the first antenna tuner is a receive (DRX) antenna switch for receiving signals from one of the first antennas, the second antenna tuner is a transceive (TRX) antenna switch for receiving or transmitting signals from one of the second antennas, and the antenna configuration corresponds to a plurality of switch states of the first antenna tuner and the second antenna tuner.

18. The antenna switching system according to claim 15, wherein the step of configuring software corresponding to hardware identification executed by the processor comprises:
configuring, by the processor, a drive code corresponding to an antenna tuner of the antenna module based on the hardware identification code information and a specification data of the antenna tuner; and
executing, by the processor, a configuration complete confirmation step, wherein the configuration complete confirmation step comprises generating a confirmation result by confirming whether the configurations of the hardware identification codes and the configuration softwares are completed, and determining whether to execute a physical code configuration step and a path code configuration step based on the confirmation result.

19. The antenna switching system according to claim 18, wherein:
the physical code configuration step comprises configuring, by the processor, a physical code corresponding to the antenna tuner based on the hardware identification code information and the specification data;
the path code configuration step comprises configuring, by the processor, a path code corresponding to the antenna tuner based on the hardware identification code information, the specification data, and the drive code;
after the path code configuration step is executed, the processor repeats the configuration complete confirmation step to generate the confirmation result;
when the confirmation result is affirmative, the processor ends the step of configuring software corresponding to hardware identification; and
when the confirmation result is negative, the processor executes the physical code configuration step and the path code configuration step.

20. The antenna switching system according to claim 15, wherein the memory is a non-volatile (NV) memory, and the communication device executes a Linux operating system.
